(19) United States
(12) Patent Application Publication
(10) Pub. No.: US 2010/0307037 A1
(43) Pub. Date: Dec. 9, 2010

(54) Digital gravestone

(76) Inventor: Cun Sang Chi, Los Angeles, CA (US)

Correspondence Address: DAVID AND RAYMOND PATENT FIRM, 108 N. YNEZ AVE., SUITE 128, MONTEREY PARK, CA, 91754, US

(21) Appl. No.: 12/455,641

(22) Filed: Jun. 3, 2009

(51) Int. Cl. G09F 19/00

(52) U.S. Cl. 40/124.5

(57) ABSTRACT

A digital gravestone includes a marker body and an inscription arrangement integral with the marker body to form the inscription on the marker body. The inscription arrangement has a digital storage for storing information in relation to the deceased, and a digital display operatively linking with the digital storage displaying the information therein, wherein the information of the deceased is adapted to be selectively updated that brings to remembrance of the deceased. A communication link is provided to operatively link to the inscription arrangement for inputting a memorable message for the deceased and updating the information of the deceased so as to share with relatives and friends of the deceased.

### BACKGROUND OF THE PRESENT INVENTION

1. Field of Invention

The present invention relates to a gravestone, and more particularly to a digital gravestone, which is adapted for displaying related information on the gravestone digitally.

2. Description of Related Arts

A conventional gravestone normally made of a durable material, such as stone, or metal, is commonly placed at a grave yard for individually distinguish each of the graves belongs to. They usually placed over or next to each of the graves in a cemetery or somewhere else. The gravestones are also provided for the convenience maintenance or management of the cemeteries.

In order to memorize the deceased people, their relatives, family, or friends usually engrave a brief histories related to the deceased people on the gravestone, such as a name of the deceased people, date of death and birth, briefly biography, and even a framed image of the deceased, other images showing the loved one, or other images relevant to their life etc. for memorial.

From time to time, the living people may want to go to the grave yard for worship of the deceased people of their friend or ancestor. They may also bring some flowers and talk to the deceased people in front of the gravestone.

However, the surface area for engraving information on the gravestone is limited and fixed. It is almost impossible to edit any words or information showed on the surface of the gravestone. It requires special tools to carve words thereon and the engraving surface is only limited within the surface of the gravestone for showing the memorial information of the deceased people. Thus, the living people can only show limited information about the deceased people for memorial. If they want to add any relatives' name of the deceased person on the gravestone after years, the still-living people may have to hire another craving profession with special tools to do the engraving job.

On the other hands, all the still living people related to the deceased people, especially those living people of beloveds of the deceased person, might want to know who had come to the grave, to show their concerns of the deceased person. However, the engraved information on the gravestone restricts any interaction of all the friends or families of the deceased people via the memorial gravestone. Living people may go to the grave yard for memorial purpose individually while they have free time. They may stand in front of the grave to speak, as if they are talking to the deceased people and refreshing the passed memories, or talking about their current living life. Thus, the living people related to the deceased people do not know who had come recently.

If the still-living people want to share any stories or memories of the deceased people with other relevant living people of the deceased people, such as deceased person's friends, it might be not easy, especially in the current busy life style. It might be hard for all still-living people of the deceased person get together to share the passed memory or talk about their own life, so as to make a connection through all the still-living people of the deceased person.

Therefore, the existing gravestone, also known as tombstone or headstone, can not provide as many information as the still-living people desired to show on the gravestone. It also can difficult to show images of the deceased, or other relevant photography as a memorial for remembrance. To leave a message to the deceased people and to let other still-living people know that he or she had come over, so as to connect between the still-living people of the deceased person, is another concerning.

### SUMMARY OF THE PRESENT INVENTION

A main object of the present invention is to provide a digital gravestone, wherein information of the deceased is adapted to be selectively updated that brings to remembrance of the deceased.

Another object of the present invention is to provide a digital gravestone, wherein the memorable message can be inputted in the digital gravestone to share with relatives and friends of the deceased.

Another object of the present invention is to provide a digital gravestone, wherein the gravestone is capable of showing a lot of information on the gravestone relevant to a deceased person.

Another object of the present invention is to provide a digital gravestone, wherein the digital gravestone is capable of updating message via wirelessly connected to an external device, such as a mobile phone or a personal computer.

Another object of the present invention is to provide a digital gravestone, wherein the digital gravestone is able to be continuously and easily edited by the still-living people.

Another object of the present invention is to provide a digital gravestone, wherein the digital gravestone is capable of displaying both visual and audio information.

Another object of the present invention is to provide a digital gravestone, wherein the gravestone has a digital display screen thereon, so that the gravestone is capable of displaying information regarding the deceased person digitally.

Another object of the present invention is to provide a digital gravestone, wherein a website address is provided on the gravestone, so that the still-living people are capable of logging in to the website of the provided website address to access the information of the deceased person with accessing permission.

Another object of the present invention is to provide a digital gravestone, wherein the digital gravestone is capable of providing a connection between the still-living people of the deceased person by leaving a message on the gravestone digitally, or accessing to the specific website having the deceased person's information and allowing the still-living people updating or editing information thereon.

Another object of the present invention is to provide a digital gravestone, wherein the still-living people are able to worship of the deceased person in a distance. In order words, the still-living people can access to the digital gravestone remotely via a wireless external device anywhere.

Accordingly, in order to accomplish the above objects, the digital gravestone of the present invention comprises:

a gravestone provided for placing over or next to the grave vertically or horizontally; and

a digital displaying system, which comprises:

a digital display mounted on the gravestone for digitally displaying relevant information of a deceased person;

a storage operatively connected to the digital display via a CPU for the displaying purpose, wherein the relevant information of the deceased person is stored therein;

a wireless connection device operatively connected to the CPU for wirelessly transferring a digital information from an external device to the digital displaying system; and

a power source for supplying electrical power for the digital displaying system for digitally displaying the digital information on the digital display mounted on the grave stone.

Accordingly, in order to accomplish the above objects, present invention also provides a digital gravestone comprising:

a gravestone, wherein a website address provided on the gravestone; and

a communicating system for being accessed via the website address on the gravestone, which comprises:

a communication network;

a date storage operatively connected to the communication network, which is provided for saving a digital information relevant to a plurality deceased people; and

a plurality of user stations operatively connected to the communication network, wherein each of the user stations provides an authorized user with access to the date storage via the communication network, such that the authorized users and relative coordinators thereof are capable of accessing, editing, and updating authorized relevant information in the date storage.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a digital gravestone according to a preferred embodiment of the present invention.

FIG. 2 is a sectional view of the digital gravestone according to the above preferred embodiment of the present invention.

FIG. 3 is a block diagram of the digital gravestone according to the above preferred embodiment of the present invention, illustrating the inscription arrangement are linked to from a cemetery site and being accessed by the user station via a communication network.

FIG. 4 is a perspective view of a conventional marker body of the gravestone according to the above preferred embodiment of the present invention, illustrating a contact link thereon.

FIG. 5 is a block diagram of the digital gravestone according to the above preferred embodiment of the present invention, illustrating the digital storage is integrally provided at the database storage of the control center.

### DETAILED DESCRIPTION OF THE PREFERRED EMBODIMENT

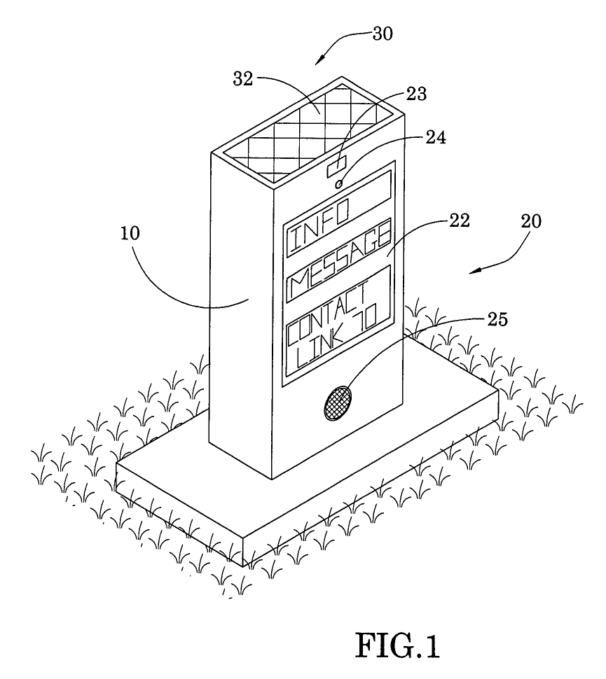

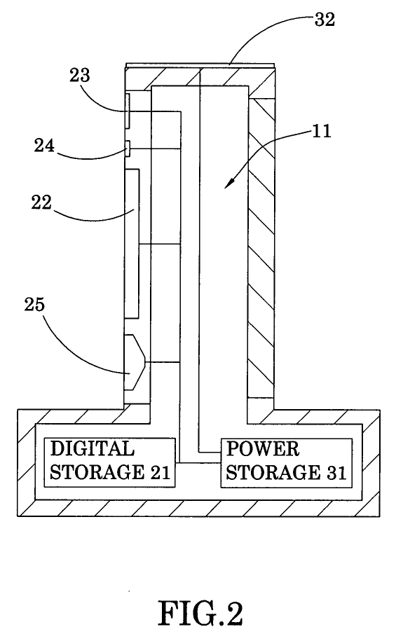

Referring to FIGS. 1 to 3 of the drawings, a digital gravestone according to a preferred embodiment of the present invention is illustrated, wherein the digital gravestone comprises a maker body 10, and an inscription arrangement 20 integrated with the marker body 10 to integrally form the digital gravestone, so that the digital gravestone is able to be placed over or next to a burial in a cemetery for reorganization each of the graves belongs to.

Accordingly, the marker body 10 is a real maker and further has a virtual image thereof. The marker body 10, having a sealing cavity 11, is provided for presenting a site of the burial in relation to the deceased, so as to display memorable information of the deceased via the inscription arrangement 20 of the digital gravestone.

The inscription arrangement 20 comprises a digital storage 21 for digitally storing information of the deceased person, and a digital display 22 operatively linked to the digital storage 21, so that the digital display 22 is capable of displaying the information stored in the digital storage 21 as an inscription of the marker body 10 of the gravestone.

The digital storage 21 is integrally sealed and received in the sealing cavity 11 of the marker body 10, and the digital display 22 is integrally sealed and mounted at the displaying side of the marker body 10 of the digital gravestone for displaying the information in relation to the deceased. In other words, the digital display 22 is mounted with the marker body 10 at a front displaying side for a vertical type gravestone, or mounted at a top displaying side for a horizontal type gravestone laying on the ground or the grave.

It is worth mentioning that the digital storage 21 and the digital display 22 of the inscription arrangement 20 are integrally sealed and received in the sealing cavity 11 of the marker body 10, so that the digital gravestone, which is waterproofed, is capable of being operated under most of the circumstances, such as rainy day. Accordingly, the digital display 22 can be a LCD mounted at the displaying side of the marker body 10.

The digital storage 21 is adapted for storing the digital information related to the deceased person, such as a name, date of birth and death, and an image of the deceased. Also, the information of a briefly biography, images of a still-living people of the deceased beloved to memorial the life time of the deceased, or even a poem, warning sentences, or memorable words in relation to the deceased are able to be stored in the digital storage 21 for displaying and memorial purposes via showing on the digital display 22 of the inscription arrangement 20.

In order to input and update the information to the digital storage 21, the inscription arrangement 20 comprises a communicating link 23 for inputting a memorable message and updating the information in relation to the deceased to be displayed on the digital display 22 for sharing with relatives and friends of the deceased. The communicating link 23 further comprises a wireless receiver 231 adapted for wirelessly receiving a signal of updating information and/or inputting messages for an external device. The updated or inputted information is capable of being saved in the digital storage 21 to be digitally displayed as the digital inscription of the digital gravestone. Accordingly, the wireless receiver 231 can be a “BlueTooth” wireless device adapted to pair with any portable electronic device having “BlueTooth” connectivity, such as PDA or mobile phone, to wireless transmit the memorable message to the digital gravestone. For example, when a friend of the deceased visited to leave the memorable message in the digital storage 21, the relatives of the deceased will know who had come to the grave, so as to provide an interactive link between friends and relatives of the deceased through the digital gravestone.

The external device could update or input information or message through directly connecting to the communication link 23 to wirely or wirelessly transferring information to the digital storage 21, so as to update the inscription for being displayed on the digital display 22 of the inscription arrangement 20. On the other hands, the external device may be a mobile phone or a personal computer, which is wirelessly connected to the wireless receiver 231 of the communication link 23 to update or input information through another communication network, such as a telecommunication network, satellite, 3G network, or an Internet, in such a manner that the message or information related to the deceased person can be wirelessly updated or inputted. The information stored in the digital storage 21 is capable of being accessed via the communication network by a user whom is authorized to access the digital storage 21.

Another example is the 3G electric device, wherein the still-living people are able to wirelessly connect to the inscription arrangement 20 via the wireless receiver 231 through a 3G network, in such a manner that the visual information on the digital display 22 or a virtual image of the marker body 10 can be concurrently displayed on the portable 3G electric device while the still-living person is uploading voice message to the digital grave stone in a distance. Thus, the wireless receiver 23 enables the still-living people to communicate with the digital grave stone visually and audibly at the same time in a distance.

It is appreciated that the communication link 23 not only provides a simple way for updating the inscription information and being displayed on the digital display 22, but also provides a wireless communicating and updating method for the still-living people of the deceased person to wirelessly transfer information to the digital storage 21, so that if the still-living people is living far away from the grave yard or cemetery, he or she is still able to pray or worship of the deceased in a distance.

In order to efficiently operate and display the digital gravestone, the inscription arrangement 20 further comprises a sensor unit 24 provided on the displaying side of the marker body 10 for automatically activating the digital gravestone to digitally display the inscription on the digital display 22. When an object, such as a still-living person of the deceased, is in a detecting range of the sensor unit 24, the sensor unit 24 will send a signal to activate the inscription arrangement 20 to digitally display the inscription via the digital display 22.

It is worth mentioning that the sensor unit 24 automatically activating the digital gravestone is capable of automatically displaying the inscription via the digital display 22 when the still-living people is standing in front of the digital gravestone in the detecting range of the sensor unit 24. The sensor unit 24 will deactivate the digital gravestone while the object is out of the detecting range, so that the digital gravestone is being automatically shut down for saving power energy of operating the digital gravestone.

The inscription arrangement 20 further comprises an audio device 25 sealed with the marker body 10 and operatively linked to the digital storage 21. The audio device 25 is provided for audibly performing audio information stored in the digital storage 21 in relation to the deceased person, such as an audio poem, scriptures of a religious being audibly played for the deceased, or the information of the deceased person.

The audio device 25 of the inscription arrangement 20 is concurrently activated while the sensor unit 24 detects the object falling within the detecting range to activate the digital gravestone, so as to automatically and efficiently display the digital visual and audio inscription information stored in the digital storage 21 via the digital display 22 and the audio device 25.

The inscription arrangement 20 further comprises an encryption program 26 for converting the received audio and/or visual information or message from the communication link 23 to another digitized data, so as to code the received information or message. In other words, the encryption program 26 is adapted for encrypting the uploaded or received audio and/or video information or message from the communication link 23 to another formation of the digital data, so as to be audibly or visually played via the digital display 22 or audio device 25 in another formation, such as converting the voice message to a higher frequency audio data for being audibly played via the audio device 25. Thus, the friends or relatives of the deceased are able to secretly pray or worship to the deceased without letting any one else known what he or she said.

Take a brain wave as another instance. The encryption program 26 is capable of converting or encrypting the received audio message from the still-living people of the deceased to a human brain wave pattern in relation to the human language, so that the brain wave pattern according to the words that the still-living people said is visually showing on the digital display 22. It is appreciated the still-living people is able to upload the voice message as a pray and being displayed as the brain wave formation or pattern in the authorized manner, so that no one else is able to understand the words that he or she said for praying. The still-living people are able to selectively choose weather or not to use the encrypting function for uploading the information or message.

The digital gravestone can also be activated by providing a button operatively linked to the inscription arrangement 20, so that when the button is being pressed, the digital visual and audio inscription of the digital gravestone is activated to start digitally displaying the visual image via the digital display 22 or playing the audio information via the audio device 25.

Accordingly, a power source is further provided and sealed for supplying electrical energy to the digital gravestone for displaying the digital visual and audio inscription information of the digital gravestone. The power source of the digital gravestone comprises a solar energy device 30 operatively linking the inscription arrangements 20 for supplying power energy thereto, wherein the solar energy device 30 comprises a power storage 31 for storing and supplying electrical power to the digital gravestone, and a solar energy collector 32.

The solar energy collector 32 is preferably provided at a top side of the marker body 10 of the digital gravestone facing directly toward the sun, so as to maximize gaining the sunlight. The collector 32 collects the solar energy and transfers the solar energy to the power storage 31, so that the power storage 31 converts the solar energy collected via the solar energy collector 32 to electrical energy, and stores the electrical energy therein for further supplying the necessary electrical energy to activate and operate the digital gravestone.

It is worth mentioning that the solar energy device 30 solved the inconvenience of a conventional method using a battery as the power source for supply power energy. It requires to change or charge the battery frequently or within a predetermined time period. The solar energy device 30 incorporated with the digital gravestone provides an efficient and convenient power supplying system to display the digital inscription information of the digital gravestone.

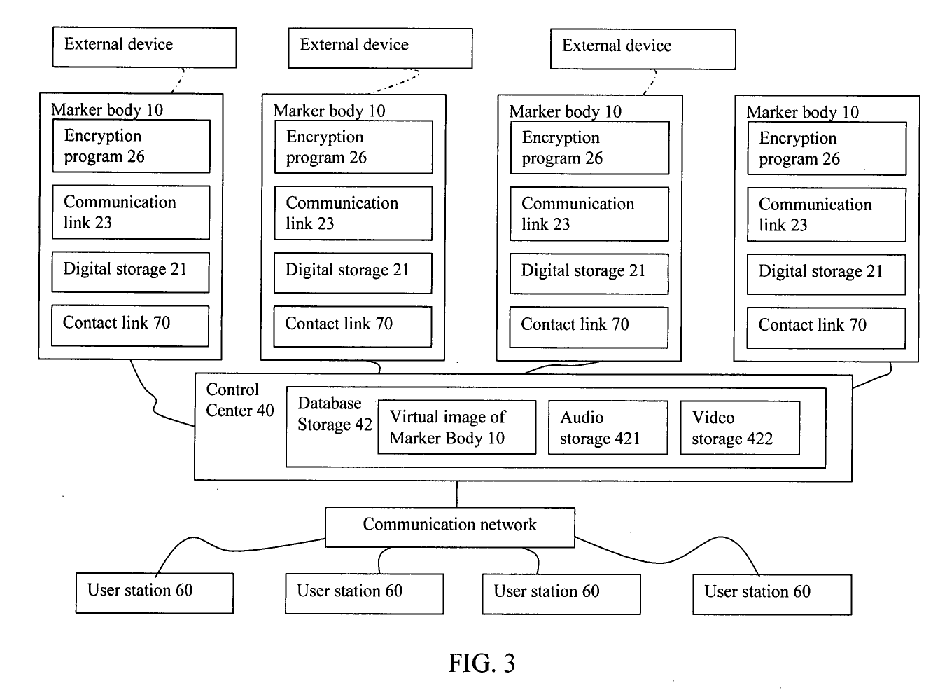

Referring to FIG. 3 of the drawings, the digital gravestone further comprises a control center 40 for operatively linking at least two or more the inscription arrangements 20 of the digital gravestones respectively to form a cemetery site. The control center 40 is operatively linked to each of the digital storages 21 of the inscription arrangements 20 of the digital gravestone. The cemetery site is operatively linking to the communication network, which is embodied as an Internet, for enabling the information of the deceased stored in the digital storage 21 being remotely updated in a distance in an authorized manner via the Internet of the communication network. In other words, the users are able to access the digital storage 21 via going to the cemetery site in the authorized manner.

It is worth mentioning that the authorized manner is preferably through a set of account and a password according to the account in a log in manner, wherein after the user registered, he or she is able to log in with the account and password to the cemetery site for accessing the authorized information.

After the user is authorized to enter the burial site in the cemetery website, the user may further invite more people, such as friends or other relatives, to joint a guest list, or friend list of the burial site, such that other people of the deceased can browse the information or message on the burial site of the cemetery site. More specifically, the user may send the invitations via email system, so that other friends or relatives of the deceased can also register to browse and/or edit and upload information through the cemetery site.

Accordingly, a plurality of user stations 60, such as personal computers, cell phone, or other devices which is capable of wirelessly connecting to the communication network in a distance, are operatively connected to the Internet of the communication network, wherein each of the user stations 60 provides an authorized user with access to the specific digital storage 21 via the communication network, such that the authorized users and/or relative coordinators thereof are capable of accessing, editing, uploading, and updating authorized relevant information of the deceased in the digital storages 21 respectively.

Each of the authorized users, such as the still-living people of the deceased, is able to access the information stored in digital storage 21, which he or she is authorized to access. Through connecting the user station 60 to the Internet of the communication network, the users can send a message to the digital storage 21 of the inscription arrangement 20 of digital gravestone in a distance, as if they went to the grave yard or the cemetery place to worship the deceased.

The authorized users are able to input the messages from the user station 60 to the cemetery site, so that the inputted messages are able to be seen by other related authorized users from the cemetery site in a distance, or from the digital display 22 in a grave yard when the still-living people of the deceased stand in front of the digital gravestone for example, in such a manner that the still-living people of the deceased can keep in touch or sharing video or audio information in relation to the deceased with each other.

The user, for instance, may send a message to inform other authorized users of the deceased that he or she came on a certain day to the grave yard, and upload a video clip of a memorable moment that they spent with the deceased to the digital storage 21 for memorial the deceased and sharing with other still-living people of the deceased.

Accordingly, the virtual image of the marker body 10 will be displayed on a screen of the user station 60, such as a computer screen. The virtual image of the marker body 10 is equivalent to the physical marker body 10, which has the digital display 22 digitally showed in front of the marker body 10 and the digital storage 21 operatively linked to the digital display 22 for displaying the information saved in the digital storage 21 and being displayed on the digital display 22 in front of the virtual marker body 10 as the digital inscription of the digital gravestone. Therefore, the virtual image of the marker body 10 is a virtual grave marker representing the deceased.

As described above, the control center 40 further comprises a database storage 42 for storing a plurality of information in relation to the deceased people, such as the digital virtual marker bodies 10 of the grave marker images are saved on the database storage 42 of the control center 40, in such a manner that the digital gravestone is capable of being displayed in front of the screen of the user station 60, and being accessed to the digital storage 21 of the inscription arrangement 20 in a distance from the user station 60. It is appreciated that the virtual marker bodies 10 enable the user to worship the deceased as if the user is standing in front of the burial of the deceased, so as to memorial the deceased.

The users can surf to the cemetery site to edit, upload, input messages or information in relation to the deceased by their personal computers of the user stations 60 in a distance, wherein the cemetery site comprises a home page having a user log in interface provided for authorized users to access the information stored or linked in the control center 40. The users are able to edit the inscription information, upload video or audio information, or input a message to the deceased after they are authorized to enter the web cemetery site.

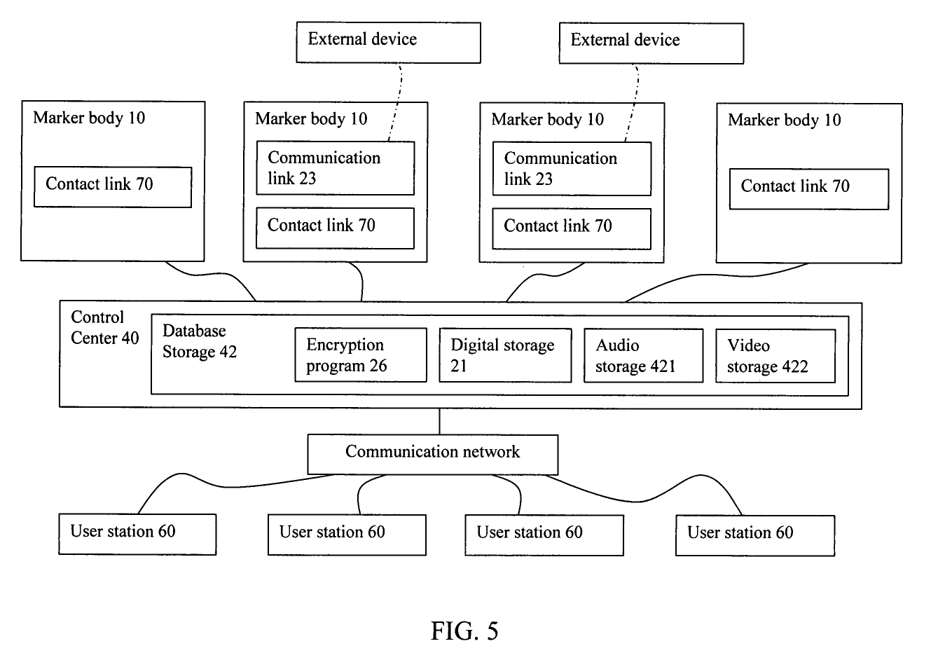

As shown in FIG. 5, the database storage 42 of the control center 40, as above preferred embodiment described, further comprises a plurality of audio databases 421 for storing an audio data for being played by the audio device 25, and a plurality of video database 422 for storing video data of the deceased people for being displayed on the digital display 22, in such a manner that the authorized users are capable of accessing the digital information related to the deceased on the cemetery site through the Internet of the communication network in a distance.

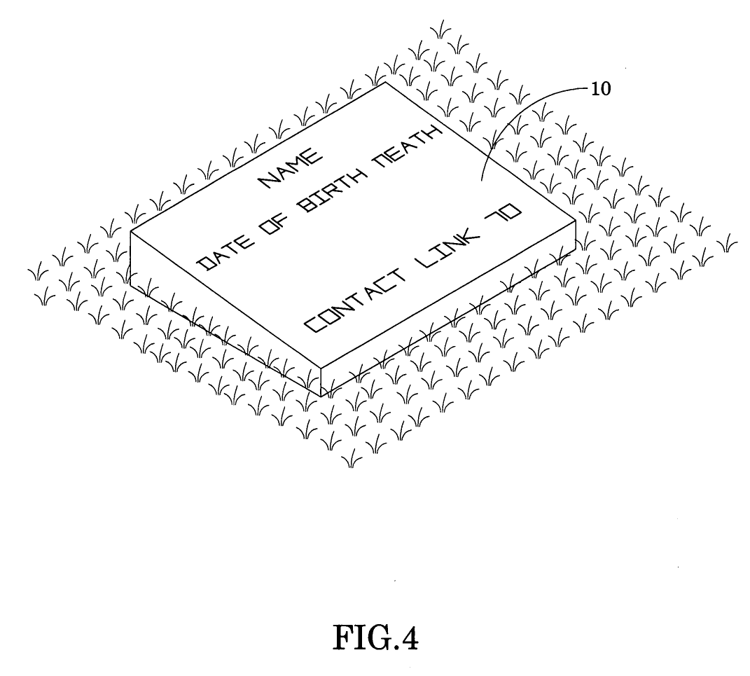

As shown in FIG. 4, a contact link 70 is provided on the front displaying side of the marker body 10, so that the authorized users of the still-living people of deceased are able to find out an online location of the inscription arrangement 20 in responsive to the deceased burial on the cemetery site, where has the digital information in relation to the deceased for being accessed by the users in an authorization manner. In other words, the user is able to browse the information in relation to the deceased by typing the contact link 70 provided on the marker body 10.

It is appreciated that the marker body 10 can be a traditional grave marker being placed over or next to the burial of a deceased in a grave yard or cemetery so as to recognize each of the graves belongs to, wherein the contact link 70 is further engraved on the front displaying side of the marker body 10. In this case, the marker body 10 may has simple and brief information, such as a name of the deceased, carved thereon, wherein the relatives and friends are able to update and send memorable message and the information in relation to the deceased through the contact link 70 of the cemetery site. It is appreciated that when the marker body 10 is embodied as the traditional grave marker, the digital storage 21 and the encryption program 26 can be embodied as a virtual storage and program provided in the control center 40, as shown in FIG. 5.

Accordingly, the virtual image of the marker body 10 will be virtually displayed on a burial site of the cemetery site in relation to the deceased, as the same as the above mentioned virtual marker body 10. Thus, through the contact link 70 on the marker body 10, the still-living people of the deceased may be able to browse, edit, upload, input messages to the deceased, or information in relation to the deceased via the user stations 60 for sharing purpose.

The authorized users are able to go to the cemetery site according to the contact link 70 via the Internet to access the database storage 42 in the control center 40, so as to perform and access the video and audio information saved on the video database 422 and audio database 421 respectively.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A digital gravestone, comprising:
a marker body adapted for representing a site of a burial in relation to the deceased, wherein said marker body has a sealing cavity; and
an inscription arrangement, which is integrated with said marker body, comprising:
a digital storage sealed and received in said sealing cavity of said marker body for storing information of the deceased including the name of the deceased, a digital image of the deceased, and the date of birth and death of the deceased, wherein the information of the deceased saved in said digital storage is adapted to be selectively updated that brings to remembrance of the deceased;
a digital display sealed and provided at a displaying side of said marker body to operatively link to said digital storage for displaying the information of the deceased to form an inscription of said marker body; and
a communication link received in said marker body to operatively link to said digital storage for inputting a memorable message for the deceased and updating the information of the deceased to be displayed on said digital display so as to share with relatives and friends of the deceased.

2. The digital gravestone, as recited in claim 1, wherein said communication link comprises a wireless receiver adapted for wirelessly linking with an external electronic device to receive the memorable message for the deceased being saved in said digital storage.

3. The digital gravestone, as recited in claim 1, wherein said inscription arrangement further comprises an audio device supported by said marker body and operatively linked with said digital storage, such that when said digital display is activated, said audio device is concurrently activated for generating an audio effect in responsive to said information of the deceased displayed on said digital display.

4. The digital gravestone, as recited in claim 2, wherein said inscription arrangement further comprises an audio device supported by said marker body and operatively linked with said digital storage, such that when said digital display is activated, said audio device is concurrently activated for generating an audio effect in responsive to said information of the deceased displayed on said digital display.

5. The digital gravestone, as recited in claim 3, wherein said digital storage comprises a video database for storing video data of the deceased to be displayed on said digital display and an audio database for storing audio data for the deceased to be played by said audio device, wherein said video and audio data are authorized for being uploaded that brings to remembrance of the deceased.

6. The digital gravestone, as recited in claim 4, wherein said digital storage comprises a video database for storing video data of the deceased to be displayed on said digital display and an audio database for storing audio data for the deceased to be played by said audio device, wherein said video and audio data are authorized for being uploaded that brings to remembrance of the deceased.

7. The digital gravestone, as recited in claim 1, wherein said inscription arrangement further comprises a sensor unit, having a detecting range, provided at said displaying side of said marker body and arranged in such a manner that said digital display is automatically activated for displaying said inscription when said sensor detects a presence of person in front of said marker body within said detecting range.

8. The digital gravestone, as recited in claim 2, wherein said inscription arrangement further comprises a sensor unit, having a detecting range, provided at said displaying side of said marker body and arranged in such a manner that said digital display is automatically activated for displaying said inscription when said sensor detects a presence of person in front of said marker body within said detecting range.

9. The digital gravestone, as recited in claim 6, wherein said inscription arrangement further comprises a sensor unit, having a detecting range, provided at said displaying side of said marker body and arranged in such a manner that said digital display is automatically activated for displaying said inscription when said sensor detects a presence of person in front of said marker body within said detecting range.

10. The digital gravestone, as recited in claim 1, further comprising a solar energy device operatively linked to said inscription arrangement, wherein said solar energy device comprises a power storage received in said sealing cavity for supplying electrical energy to said inscription arrangement, and a solar energy collector supported on said marker body for directly facing towards sunlight to maximize solar energy collection and to convert said solar energy into said electrical energy to be stored in said power storage.

11. The digital gravestone, as recited in claim 6, further comprising a solar energy device operatively linked to said inscription arrangement, wherein said solar energy device comprises a power storage received in said sealing cavity for supplying electrical energy to said inscription arrangement, and a solar energy collector supported on said marker body for directly facing towards sunlight to maximize solar energy collection and to convert said solar energy into said electrical energy to be stored in said power storage.

12. The digital gravestone, as recited in claim 9, further comprising a solar energy device operatively linked to said inscription arrangement, wherein said solar energy device comprises a power storage received in said sealing cavity for supplying electrical energy to said inscription arrangement, and a solar energy collector supported on said marker body for directly facing towards sunlight to maximize solar energy collection and to convert said solar energy into said electrical energy to be stored in said power storage.

13. The digital gravestone, as recited in claim 1, further comprising a control center communicating linking said inscription arrangement with another said inscription arrangement to form a cemetery site, wherein said control center is operatively linked to said digital storage for enabling said information of the deceased being updated in a distance in an authorized manner.

14. The digital gravestone, as recited in claim 6, further comprising a control center communicating linking said inscription arrangement with another said inscription arrangement to form a cemetery site, wherein said control center is operatively linked to said digital storage for enabling said information of the deceased being updated in a distance in an authorized manner.

15. The digital gravestone, as recited in claim 12, further comprising a control center communicating linking said inscription arrangement with another said inscription arrangement to form a cemetery site, wherein said control center is operatively linked to said digital storage for enabling said information of the deceased being updated in a distance in an authorized manner.

16. The digital gravestone, as recited in claim 13, wherein said control center is authorized and controlled to access said digital storage through Internet.

17. The digital gravestone, as recited in claim 14, wherein said control center is authorized and controlled to access said digital storage through Internet.

18. The digital gravestone, as recited in claim 15, wherein said control center is authorized and controlled to access said digital storage through Internet.

19. A digital gravestone, comprising:
a plurality of marker bodies, wherein each of said marker bodies comprises a physical grave marker being placed at the site of the burial in relation to the deceased, and a virtual image of said marker body;
a plurality of inscription arrangements integrated with said virtual images of said marker bodies to form inscriptions of said marker bodies respectively, wherein each of said inscription arrangements comprises a digital storage for storing information of the deceased including the name of the deceased, a digital image of the deceased, and the date of birth and death of the deceased, and a communication link received in said marker body to operatively link to said digital storage for inputting a memorable message for the deceased and updating the information of the deceased to be displayed on said digital display so as to share with relatives and friends of the deceased; and
a control center communicating linking said inscription arrangement with another said inscription arrangement to form a cemetery site, wherein said control center is operatively linked to each of said digital storages for enabling said information of the deceased being remotely updated in a distance in an authorized manner.

20. The digital gravestone, as recited in claim 19, wherein said control center is authorized and controlled to access said digital storage through Internet for inputting said memorable message for the deceased and updating the information of the deceased.

21. The digital gravestone, as recited in claim 19, wherein said digital storage comprises a video database for storing video data of the deceased and an audio database for storing audio data for the deceased, wherein said video and audio data are authorized through said control center for being uploaded that brings to remembrance of the deceased.

22. The digital gravestone, as recited in claim 20, wherein said digital storage comprises a video database for storing video data of the deceased and an audio database for storing audio data for the deceased, wherein said video and audio data are authorized through said control center for being uploaded that brings to remembrance of the deceased.

23. The digital gravestone, as recited in claim 19, wherein said communication link comprises a wireless receiver adapted for wirelessly linking with an external electronic device to receive the memorable message for the deceased being saved in said digital storage.

24. The digital gravestone, as recited in claim 22, wherein said communication link comprises a wireless receiver adapted for wirelessly linking with an external electronic device to receive the memorable message for the deceased being saved in said digital storage.

25. The digital gravestone, as recited in claim 19, wherein said control center comprises a contact link provided on each of said marker bodies to identify an online location of said respective inscription arrangement through said control center, such that said control center is operatively linked to each of said digital storages for enabling said information of the deceased being remotely updated in a distance in an authorized manner.

26. The digital gravestone, as recited in claim 24, wherein said control center comprises a contact link provided on each of said marker bodies to identify an online location of said respective inscription arrangement through said control center, such that said control center is operatively linked to each of said digital storages for enabling said information of the deceased being remotely updated in a distance in an authorized manner.

27. A digital gravestone, comprising:
a marker body adapted for representing a site of a burial in relation to the deceased; and
an inscription arrangement, which is integrated with said marker body, comprising:
a digital storage sealed and received in said marker body for storing information of the deceased including the name of the deceased, a digital image of the deceased, and the date of birth and death of the deceased, wherein the information of the deceased saved in said digital storage is adapted to be selectively updated that brings to remembrance of the deceased; and
a communication link received in said marker body to operatively link to said digital storage for inputting a memorable message for the deceased and updating the information of the deceased to be displayed on said digital display so as to share with relatives and friends of the deceased; and
a contact link provided on said marker body to identify an online location of said respective inscription arrangement for enabling said information of the deceased being remotely updated in a distance in an authorized manner.

28. The digital gravestone, as recited in claim 27, wherein said communication link comprises a wireless receiver adapted for wirelessly linking with an external electronic device to receive the memorable message for the deceased being saved in said digital storage.
